(19) United States
(12) Patent Application Publication
(10) Pub. No.: US 2020/0007794 A1
(43) Pub. Date: Jan. 2, 2020

(54) IMAGE TRANSMISSION METHOD, APPARATUS, AND DEVICE

(71) Applicant: SZ DJI TECHNOLOGY CO., LTD., Shenzhen (CN)

(72) Inventors: Jun WU, Shenzhen (CN); Huaiyu LIU, Shenzhen (CN); Xiufeng GAO, Shenzhen (CN)

(21) Appl. No.: 16/567,862

(22) Filed: Sep. 11, 2019

Related U.S. Application Data
(63) Continuation of application No. PCT/CN2017/077463, filed on Mar. 21, 2017.

(51) Int. Cl. H04N 5/262; H04N 5/232; H04N 7/04; G06T 5/00; B64C 39/02

(52) U.S. Cl. CPC H04N 5/2628; H04N 5/23238; H04N 7/04; G06T 5/006; B64C 2201/127; B64C 39/02; G06T 2207/20104; G06T 2207/10032; H04N 5/23206

(57) ABSTRACT

An image transmission method includes receiving region of interest (ROI) information sent by a display device, performing image processing on a captured image according to the ROI information to intercept a partial image indicated by the ROI information from the captured image, and sending the partial image to the display device.

### CROSS-REFERENCE TO RELATED APPLICATION

This application is a continuation of International Application No. PCT/CN2017/077463, filed on Mar. 21, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to image processing technology and, more particularly, to an image transmission method, apparatus, and device.

### BACKGROUND

A camera device uses an ultra-wide field-of-view (FOV) lens to capture a wide-FOV image. For example, a fisheye lens achieves a FOV as wide as, e.g., 220° or 230°. The camera device is integrated with at least two lenses to obtain a panoramic image. For example, the panoramic image is obtained by synthesizing images captured by the at least two lenses, and then the synthesized panoramic image is sent to a display device, such that the display device displays the panoramic image. Thus, the images captured by the camera device have a high resolution, however a transmission bandwidth needs to be high enough to transmit the images. For example, at least 20 Megabits per second (Mbps) transmission bandwidth is required for a compressed bitstream obtained by encoding the panoramic images, with a resolution of 4096×2048 shot at 30 frames per second (fps), using H. 264 standard. A conventional wireless transmission system uses electromagnetic waves as a transmission medium to transmit data information based on modulation and demodulation technologies. Due to limitations of the modulation and demodulation technologies, physical electromagnetic bandwidth, communication distance, and environmental interference, the wireless transmission system can only provide 2 to 4 Mbps bandwidth with a transmission distance of a few hundred to several kilometers. The small transmission bandwidth causes an image transmission delay, a playback to frequently stop at the display device, a non-smooth playback, or the like.

### SUMMARY

In accordance with the disclosure, there is provided an image transmission method including receiving region of interest (ROI) information sent by a display device, performing image processing on a captured image according to the ROI information to intercept a partial image indicated by the ROI information from the captured image, and sending the partial image to the display device.

Also in accordance with the disclosure, there is provided an image transmission apparatus including a memory storing program codes and a processor coupled to the memory and configured to execute the program codes to receive region of interest (ROI) information sent by a display device, perform image processing on a captured image according to the ROI information to intercept a partial image indicated by the ROI information from the captured image, and send the partial image to the display device.

Also in accordance with the disclosure, there is provided a camera device including a network interface, a memory coupled to the network interface and storing program codes, and a processor coupled to the memory and the network interface and configured to execute the program codes to receive region of interest (ROI) information sent by a display device via the network interface, perform image processing on a captured image according to the ROI information to intercept a partial image indicated by the ROI information from the captured image, and send the partial image to the display device via the network interface.

### BRIEF DESCRIPTION OF THE DRAWINGS

In order to illustrate the technical solutions of the present disclosure, the drawings used in the description of embodiments will be briefly described. The drawings illustrate some rather than all of the embodiments of the present disclosure. Other drawings conceived by those having ordinary skills in the art on the basis of the described drawings without inventive efforts should fall within the scope of the present disclosure.

FIG. 1 is a schematic architecture diagram of an image transmission system consistent with the disclosure.

FIG. 2 is a schematic flow chart of an image transmission method consistent with the disclosure.

FIG. 3 is a schematic structure diagram of a camera device consistent with the disclosure.

FIG. 4 is a schematic structure diagram of an image transmission apparatus consistent with the disclosure.

### DETAILED DESCRIPTION OF THE EMBODIMENTS

In order to illustrate the technical solutions of the present disclosure, example embodiments will be described with reference to the accompanying drawings hereinafter.

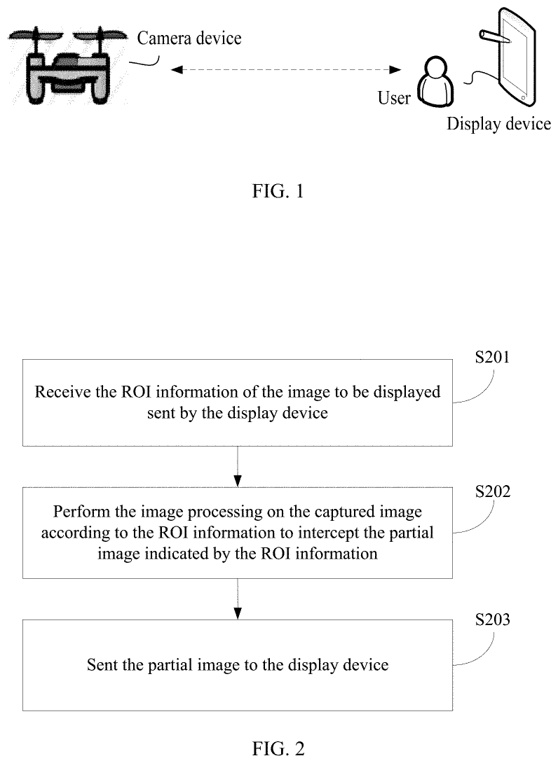

FIG. 1 is a schematic architecture diagram of an example image transmission system consistent with the disclosure. As shown in FIG. 1, the image transmission system includes a camera device and a display device. In some embodiments, the image transmission system can include one or more camera devices and one or more display devices. A wireless connection can be established between the camera device and the display device. For example, the image can be transmitted by using electromagnetic waves as a transmission medium based on modulation and demodulation technologies. For another example, the image can be transmitted through a WI-FI connection. As another example, the camera device and the display device can connect to a same Wireless Local Area Networks (WLAN) via a wireless network card to transmit the image.

In some embodiments, the image transmission system can be an unmanned aerial vehicle (UAV) system. The camera device can include a high-resolution panoramic camera mounted at an UAV, and the display device can include a mobile device or video glasses at a ground terminal. A resolution of the display device can be lower than a resolution of the panoramic camera mounted at the UAV. The camera device can transmit a partial image to the display device via the wireless connection to assist in shooting and flying. The partial image can refer to a portion of a panoramic image captured by the panoramic camera. The partial image can include one or more pixels of the panoramic image.

In some embodiments, the camera device can include a photographing apparatus configured to capture images. For example, the photographing apparatus can include an ultra-wide field-of-view (FOV) lens. The ultra-wide FOV lens can have an FOV as wide as 220° or 230°. As another example, the photographing apparatus can include at least two lenses. Sub-images (also referred to as “unit images”) captured by the at least two lenses can be spliced to obtain the panoramic image, such that an image acquisition having a 360° FOV can be achieved.

The display device can include a display screen. The display device can receive the partial image transmitted by the camera device via the wireless connection between the camera device and the display device, and display the partial image on the display screen.

In some embodiments, the display device can generate region of interest (ROI) information for an image to be displayed, and transmit the ROI information to the camera device. In this way, the partial image can include the ROI of the image. The camera device can perform an image processing on the captured image according to the ROI information, such that the partial image indicated by the ROI information can be intercepted from the captured image, and the partial image can be transmitted to the display device. The ROI information can include size information of the ROI and direction-position information of the ROI.

In some embodiments, the display device can include a preset sensor. The preset sensor can obtain the direction-position information of the ROI. The direction-position information of the ROI can include, for example, direction information and position information of the ROI. For example, the position information of the ROI can include a position of a central point of the ROI, a position of a top left pixel of the ROI, and/or the like. The direction information can include an angle between a line of sight passing through the central point of the ROI and another line of sight passing through a central point of the display screen, and/or the like. The preset sensor can include an inertial measurement unit (IMU), a gravity sensor, or the like.

FIG. 2 is a schematic flow chart of an example image transmission method consistent with the disclosure. As shown in FIG. 2, at 201, the ROI information of the image to be displayed sent by the display device is received.

The camera device can receive the ROI information of the image to be displayed sent by the display device. The image to be displayed can include the image captured by the camera device, such as the panoramic image or the image captured by the ultra-wide FOV lens. For example, the camera device may send an ROI request command to the display device before sending the image to the display device. The display device may notify the user to select a partial region of the image to be displayed on the display screen of the display device according to the ROI request command. The user can perform a corresponding operation on the display device. When the display device detects the operation of the user, the display device may generate the ROI information of the image to be displayed, and send the ROI information to the camera device. As another example, the user can perform the corresponding operation on the display device. When the display device detects the operation of the user, the display device can determine the partial region of the image to be displayed on the display screen of the display device, and generate ROI information of the image to be displayed. The ROI information can be sent to the camera device. The ROI information can include the size information of the ROI and the direction-position information of the ROI. The size information of the ROI can include a length of the ROI, a width of the ROI, a diagonal length of the ROI, and/or the like.

In some embodiments, the display device can determine the size information of the ROI according to characteristics of the display device and a user experience. For example, a screen size of the display screen of the display device is 15 inches. Based on a visual experience of the user, the user may browse a central area of the display screen at a first glance, and the display device can determine that the size information of the ROI can be 5 inches. For example, the diagonal length of the ROI can be 5 inches. The size information of the ROI being 5 inches is merely an example. In some embodiments, the size information of the ROI can be 7 inches or another value, which is not limited here. As another example, the display device can determine the size of the ROI according to the screen size of the display screen and a preset visual range. For example, the size of the ROI can be equal to a minimum of the preset visual range multiplied by a distance from the user's eye to the display screen and the screen size of the display screen. In some embodiments, the preset visual range can be the visual range of VR glasses, for example, 100°.

In some embodiments, the display device can obtain the direction information and the position information of the ROI using the preset sensor. For example, the display device can determine the direction information and the position information of the ROI according to a gesture of a human body detected by the IMU. As another example, the display device can obtain an orientation of user's eye from the VR glasses, and use the orientation as the direction information of the ROI. The display device can determine the position information of the ROI according to the direction information and the preset visual range. For example, the position information of the ROI can be equal to the angle between a line of sight passing through the central point of the ROI and another line of sight passing through the central point of the display screen indicated by the direction information multiplied by the distance from the user's eye to the display screen.

In some embodiments, the direction-position information may be determined according to a sliding operation, when the display device detects that the user performs the sliding operation on a preset interface displayed on the display screen of the display device. The preset interface may include a preset image interface, a map, or the like. For example, the user can select the ROI on the display screen by sliding a finger on the display screen. The display device can determine the direction information and the position information of the ROI in the image to be displayed according to the ROI displayed on the display screen. As another example, after the display device displays the preset interface on the display screen, the user can click or frame the ROI in the display screen. The display device can determine the direction information and the position information of the ROI in the image to be displayed according to the operation of the user.

At S202, image processing is performed on the captured image according to the ROI information to intercept the partial image indicated by the ROI information. After receiving the ROI information sent by the display device, the camera device can perform the image processing on the captured image according to the ROI information to intercept the partial image indicated by the ROI information from the captured image.

In some embodiments, the camera device can determine a position of the partial image in the captured image according to the direction-position information of the ROI, and determine a size of the partial image according to the size information of the ROI. The captured image can be intercepted based on the position of the partial image and the size of the partial image. The intercepted region can be used as the partial image.

In some embodiments, the camera device can include at least two lenses. The sub-images captured by the at least two lenses can be spliced in a panoramic manner. The partial image indicated by the ROI information can be intercepted from the spliced panoramic image.

In some embodiments, the camera device can determine coordinates information of the partial image from the captured image according to the ROI information. The coordinates information of the partial image can include, for example, coordinates of a top left pixel of the partial image, coordinates of a bottom right pixel of the partial image, and/or the like. A region indicated by the coordinates information of the partial image can be intercepted from the captured image, and the intercepted region can be used as the partial image.

In some embodiments, the camera device can correct distortions of the captured image to obtain a corrected image. The image processing can be performed on the corrected image according to the ROI information to intercept the partial image indicated by the ROI information from the corrected image.

At S203, the partial image is sent to the display device. After the camera device intercepts the partial image indicated by the ROI information from the captured image, the partial image can be transmitted to the display device, such that the display device can display the partial image on the display screen of the display device.

In some embodiments, the camera device can compress and encode the partial image such that a smaller space and bandwidth can be used for storage and transmission. The camera device can transmit the compression-encoded partial image to the display device through the wireless connection with the display device. The display device can decompress the compression-encoded partial image and display the decompressed partial image.

Consistent with the disclosure, the partial image of the ROI of the user can be intercepted and transmitted, such that a high-resolution image display experience can be achieved with limited wireless bandwidth. According to the image transmission method in FIG. 2, the ROI information of the image to be displayed sent by the display device can be received by the camera device. The image can be processed according to the ROI information, such that the partial image indicated by the ROI information can be intercepted from the captured image, and the partial image can be transmitted to the display device, thereby improving an image transmission efficiency.

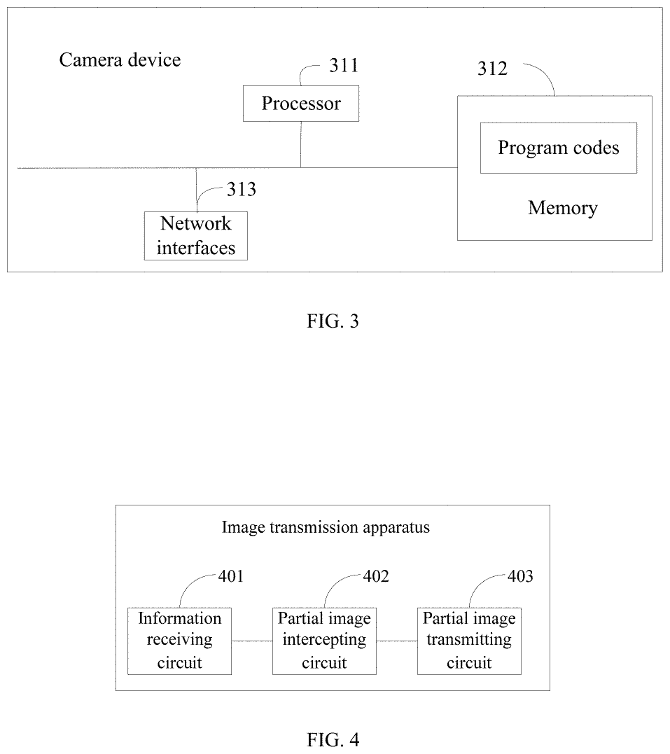

FIG. 3 is a schematic structure diagram of an example camera device consistent with the disclosure. As shown in FIG. 3, the camera device includes a processor 311, a memory 312 coupled to the processor 311, and one or more network interfaces 313 coupled to the processor 311 and the memory 312.

In some embodiments, the camera device can include one or more processors 311. The processor 311 may include a CPU, a network processor (NP), or the like. The one or more network interfaces 313 can include a network adapter or a physical network card for connecting to any connectable network, for example, the Internet, a corporate network, and/or the like.

The memory 312 can be configured to store the images, the ROI information, and/or the like. The memory 312 can include a volatile memory, for example, a random-access memory (RAM), or can include a non-volatile memory, for example, a read-only memory (ROM), a flash memory, a hard disk drive (HDD), or a solid-state drive (SSD), or can include a combination of the memories described above.

The processor 311 can execute program codes stored in the memory 312 and implement the following processes. The ROI information of the image to be displayed sent by the display device can be received via the one or more network interfaces 313. The image processing can be performed on the captured image according to the ROI information to intercept the partial image indicated by the ROI information from the captured image. The partial image can be transmitted to the display device via the one or more network interfaces 313.

In some embodiments, the ROI information can include the size information of the ROI and the direction-position information of the ROI. In some embodiments, the direction-position information can include the direction information and the position information obtained by the preset sensor. In some embodiments, the direction-position information may be determined according to the sliding operation, when the display device detects that the user performs the sliding operation on the preset interface displayed on the display screen of the display device.

In some embodiments, the processor 311 can perform the image processing on the captured image according to the ROI information to intercept the partial image indicated by the ROI information from the captured image. For example, the processor 311 can determine the coordinates information of the partial image from the captured image according to the ROI information. The region indicated by the coordinates information of the partial image can be intercepted from the captured image, and the intercepted region can be used as the partial image.

As another example, the processor 311 can correct the distortions of the captured image to obtain the corrected image. The image processing can be performed on the corrected image according to the ROI information to intercept the partial image indicated by the ROI information from the corrected image.

The camera device in FIG. 3 can implement some or all of the processes of the image transmission method in FIG. 2.

FIG. 4 is a schematic structure diagram of an example image transmission apparatus consistent with the disclosure. The image transmission apparatus can be implemented in a camera device and can be integrated in, e.g., the processor 311 in FIG. 3. As shown in FIG. 4, the image transmission apparatus includes at least an information receiving circuit 401, a partial image intercepting circuit 402 coupled to the information receiving circuit 401, and a partial image transmitting circuit 403 couple to the partial image intercepting circuit 402.

The information receiving circuit 401 can be configured to receive the ROI information of the image to be displayed sent by the display device. The partial image intercepting circuit 402 can be configured to perform the image processing on the captured image according to the ROI information to intercept the partial image indicated by the ROI information from the captured image. The partial image transmitting circuit 403 can be configured to send the partial image to the display device.

In some embodiments, the ROI information can include the size information of the ROI and the direction-position information of the ROI. In some embodiments, the direction-position information can include the direction information and the position information obtained by the preset sensor. In some embodiments, the direction-position information may be determined according to the sliding operation, when the display device detects that the user performs the sliding operation on the preset interface displayed on the display screen of the display device.

In some embodiments, the partial image intercepting circuit 402 can be configured to determine the coordinates information of the partial image from the captured image according to the ROI information, and interpret the region indicated by the coordinates information of the partial image from the captured image.

In some embodiments, the partial image intercepting circuit 402 can be configured to correct the distortions of the captured image to obtain the corrected image and perform the image processing on the corrected image according to the ROI information to intercept the partial image indicated by the ROI information from the corrected image.

The image transmission apparatus in FIG. 4 can implement some or all of the processes of the image transmission method in FIG. 2.

As used herein, the terms “an embodiment,” “some embodiments,” “an example embodiment,” “an example,” “certain example,” “some examples,” or the like, refer to that the specific features, structures, materials, or characteristics described in connection with the embodiments or examples are included in at least one embodiment or example of the disclosure. The illustrative representations of the above terms are not necessarily referring to the same embodiments or examples. Furthermore, the specific features, structures, materials, or characteristics described may be combined in a suitable manner in any one or more embodiments or examples. Those skilled in the art can combine the different embodiments or examples described in the specification and the features of the different embodiments or examples without conflicting each other.

The terms “first,” “second,” or the like in the specification, claims, and the drawings of the disclosure are merely illustrative, e.g. distinguishing similar elements, defining technical features, or the like, and are not intended to indicate or imply the importance of the corresponding elements or the number of the technical features. Thus, features defined as “first” and “second” may explicitly or implicitly include one or more of the features. As used herein, “multiple” means two or more, unless there are other clear and specific limitations.

The logics and/or processes described in the flowcharts or in other manners may be, for example, an order list of the executable instructions for implementing logical functions, which may be implemented in any computer-readable storage medium and used by an instruction execution system, apparatus, or device, such as a computer-based system, a system including a processor, or another system that can fetch and execute instructions from an instruction execution system, apparatus, or device, or used in a combination of the instruction execution system, apparatus, or device. The computer-readable storage medium may be any apparatus that can contain, store, communicate, propagate, or transmit the program for using by or in a combination of the instruction execution system, apparatus, or device. The computer readable medium may include, for example, an electrical assembly having one or more wires, e.g., electronic apparatus, a portable computer disk cartridge. e.g., magnetic disk, a random access memory (RAM), a read only memory (ROM), an erasable programmable read only memory (EPROM or flash memory), an optical fiber device, or a compact disc read only memory (CDROM). In addition, the computer readable medium may be a paper or another suitable medium upon which the program can be printed. The program may be obtained electronically, for example, by optically scanning the paper or another medium, and editing, interpreting, or others processes, and then stored in a computer memory.

Those of ordinary skill in the art will appreciate that the example elements and steps described above can be implemented in electronic hardware, computer software, firmware, or a combination thereof. Multiple processes or methods may be implemented in a software or firmware stored in the memory and executed by a suitable instruction execution system. When being implemented in an electronic hardware, the example elements and processes described above may be implemented using any one or a combination of: discrete logic circuits having logic gate circuits for implementing logic functions on data signals, specific integrated circuits having suitable combinational logic gate circuits, programmable gate arrays (PGA), field programmable gate arrays (FPGAs), and the like.

The integrated unit described above may be implemented in electronic hardware or computer software. The integrated unit may be stored in a computer readable medium, which can be sold or used as a standalone product.

It is intended that the embodiments disclosed herein be considered as example only and not to limit the scope of the disclosure. Changes, modifications, alterations, and variations of the above-described embodiments may be made by those skilled in the art within the scope of the disclosure. The scope of the invention is defined by the following claims.

What is claimed is:

1. An image transmission method comprising:
receiving region of interest (ROI) information sent by a display device;
performing image processing on a captured image according to the ROI information to intercept a partial image indicated by the ROI information from the captured image; and
sending the partial image to the display device.

2. The method of claim 1, wherein the ROI information comprises size information of an ROI and direction-position information of the ROI.

3. The method of claim 2, wherein the direction-position information comprises direction information and position information of the ROI obtained by a preset sensor.

4. The method of claim 2, wherein the direction-position information is determined according to a sliding operation performed on a preset interface displayed on a display screen of the display device.

5. The method of claim 1, wherein performing the image processing on the captured image comprises:
determining coordinates information of the partial image from the captured image according to the ROI information; and
intercepting a region indicated by the coordinates information of the partial image from the captured image as the partial image.

6. The method of claim 1, wherein performing the image processing on the captured image comprises:
correcting distortions of the captured image to obtain a corrected image; and
performing the image processing on the corrected image according to the ROI information, to intercept the partial image indicated by the ROI information from the corrected image.

7. An image transmission apparatus comprising:
a memory storing program codes; and
a processor coupled to the memory and configured to execute the program codes to:
receive region of interest (ROI) information sent by a display device;
perform image processing on a captured image according to the ROI information to intercept a partial image indicated by the ROI information from the captured image; and
send the partial image to the display device.

8. The apparatus of claim 7, wherein the ROI information comprises size information of an ROI and direction-position information of the ROI.

9. The apparatus of claim 8, wherein the direction-position information comprises direction information and position information of the ROI obtained by a preset sensor.

10. The apparatus of claim 8, wherein the direction-position information is determined according to a sliding operation performed on a preset interface displayed on a display screen of the display device.

11. The apparatus of claim 7, wherein the processor is further configured to execute the program codes to:
determine coordinates information of the partial image from the captured image according to the ROI information; and
intercept a region indicated by the coordinates information of the partial image from the captured image as the partial image.

12. The apparatus of claim 7, wherein the processor is further configured to execute the program codes to:
correct distortions of the captured image to obtain a corrected image; and
perform the image processing on the corrected image according to the ROI information, to intercept the partial image indicated by the ROI information from the corrected image.

13. A camera device comprising:
a network interface;
a memory coupled to the network interface and storing program codes; and
a processor coupled to the memory and the network interface, and configured to execute the program codes to:
receive region of interest (ROI) information sent by a display device via the network interface;
perform image processing on a captured image according to the ROI information to intercept a partial image indicated by the ROI information from the captured image; and
send the partial image to the display device via the network interface.

14. The device of claim 13, wherein the ROI information comprises size information of an ROI and direction-position information of the ROI.

15. The device of claim 14, wherein the direction-position information comprises direction information and position information of the ROI obtained by a preset sensor.

16. The device of claim 14, wherein the direction-position information is determined according to a sliding operation performed on a preset interface displayed on a display screen of the display device.

17. The device of claim 13, wherein the processor is further configured to execute the program codes to:
determine coordinates information of the partial image from the captured image according to the ROI information; and
intercept a region indicated by the coordinates information of the partial image from the captured image as the partial image.

18. The device of claim 13, wherein the processor is further configured to execute the program codes to:
correct distortions of the captured image to obtain a corrected image; and
perform the image processing on the corrected image according to the ROI information, to intercept the partial image indicated by the ROI information from the corrected image.
